(19) United States
(12) Patent Application Publication
(10) Pub. No.: US 2010/0081031 A1
(43) Pub. Date: Apr. 1, 2010

(54) POLYMER ELECTROLYTE MEMBRANE FOR DIRECT METHANOL FUEL CELL AND DIRECT METHANOL FUEL CELL

(75) Inventor: Tomoaki Arimura, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/535,558

(22) Filed: Aug. 4, 2009

(30) Foreign Application Priority Data
Sep. 26, 2008 (JP) 2008-249168

(51) Int. Cl. H01M 8/10

(52) U.S. Cl. 429/33

(57) ABSTRACT

According to one embodiment, a direct methanol fuel cell is provided with an anode to which an aqueous methanol solution is fed, a cathode to which an oxidant is fed and a polymer electrolyte membrane which is disposed between the anode and the cathode and contains a heterocyclic ester copolymer having a specific structure.

### CROSS-REFERENCE TO RELATED APPLICATIONS

This application is based upon and claims the benefit of priority from Japanese Patent Application No. 2008-249168, filed Sep. 26, 2008, the entire contents of which are incorporated herein by reference.

### BACKGROUND

1. Field

One embodiment of the present invention relates to a polymer electrolyte membrane for a direct methanol fuel cell and a direct methanol fuel cell.

2. Description of the Related Art

A direct methanol fuel cell includes an anode to which an aqueous methanol solution is fed as the fuel, a cathode to which an oxidizing agent is fed and a polymer electrolyte membrane (proton-conductive membrane) interposed between these anode and cathode. As the polymer electrolyte membrane, a perfluoroalkylsulfonic acid film, for example, Nafion 112 (trademark, manufactured by DuPont.) which is a fluorine ion exchange film is known.

However, a current polymer electrolyte membrane has affinity to methanol, since the membrane is provided with a polymer structure in which plural carbon fluorides are combined to a principal chain. For this reason, the crossover phenomenon, in which methanol supplied to the anode in the operation of a fuel cell transmits the polymer electrolyte membrane and flows towards the cathode, occurs. This results in a reduced working efficiency of methanol and in a reduction in the output of a fuel cell.

In light of this, Jpn. Pat. Appln. KOKAI Publication No. 2007-179925 discloses that a sulfonic acid polymer having a network structure, which is produced by crosslinking a vinyl polymer, is used as the polymer electrolyte membrane. The sulfonic acid polymer reduces in the occurrence of the methanol crossover phenomenon.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exploded perspective view schematically showing a unit cell of a fuel cell according to an embodiment of the present invention;

FIG. 2 is a sectional view showing a membrane electrode unit incorporated into the unit cell of FIG. 1;

FIG. 3 is a view showing a current-voltage curve of each evaluation unit cell of Examples 1 to 6 and Comparative Example 1;

FIG. 4 is a view showing a variation in the voltage of each evaluation unit cell obtained in Examples 1 to 6 and Comparative Example 1 when the cell is operated for a long period while maintaining a constant current density; and

FIG. 5 is a view showing the temperature dependency of the proton conductivity of each polymer electrolyte membrane of Examples 1 to 6 and Comparative Example 1.

### DETAILED DESCRIPTION

Various embodiments according to the invention will be described hereinafter.

In general, an embodiment according to the present invention relates to a polymer electrolyte membrane for a direct methanol fuel cell, which comprises a heterocyclic ester copolymer represented by the following formula (I):

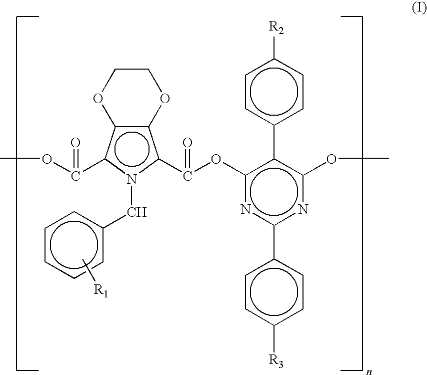

where R₁ represents a sulfonic acid group, R₂ and R₃, which may be the same or different, respectively represent a sulfonic acid group, hydrogen or fluorine and n denotes an integer of 30 to 600.

In formula I, n is preferably an integer of 60 to 300.

When both of R₂ and R₃ in formula I are sulfonic acid groups, the proton conductivity of the heterocyclic ester copolymer can be more heightened. Also, when both of R₂ and R₃ in formula I are fluorine atoms, the strength of the heterocyclic ester copolymer can be heightened.

Specific examples of the heterocyclic ester copolymer represented by formula I include 4,6-dihydroxy-2,5-diphenylpyrimidine-1-benzyl(p-sulfonic acid)-3,4-ethylenedioxypyrrole-2,5-dicarboxylate shown by the following structural formula (A), 4,6-dihydroxy-2-phenyl-5-(p-phenylsulfonic acid)pyrimidine-1-benzyl(p-sulfonic acid)-3,4-ethylenedioxypyrrole-2,5-dicarboxylate represented by the following structural formula (B), 4,6-dihydroxy-2-(p-phenylsulfonic acid)-5-phenylpyrimidine-1-benzyl(o-sulfonic acid)-3,4-ethylenedioxypyrrole-2,5-dicarboxylate represented by the following structural formula (C), 4,6-dihydroxy-2-(p-phenylsulfonic acid)-5-phenylpyrimidine-1-benzyl(p-sulfonic acid)-3,4-ethylenedioxypyrrole-2,5-dicarboxylate represented by the following structural formula (D), 4,6-dihydroxy-2-phenyl-5-(p-fluorophenyl)pyrimidine-1-benzyl(p-sulfonic acid)-3,4-ethylenedioxypyrrole-2,5-dicarboxylate represented by the following structural formula (E) and 4,6-dihydroxy-2-(p-fluorophenyl)-5(p-phenylsulfonic acid)pyrimidine-1-benzyl(p-sulfonic acid)-3,4-ethylenedioxypyrrole-2,5-dicarboxylate represented by the following structural formula (F).

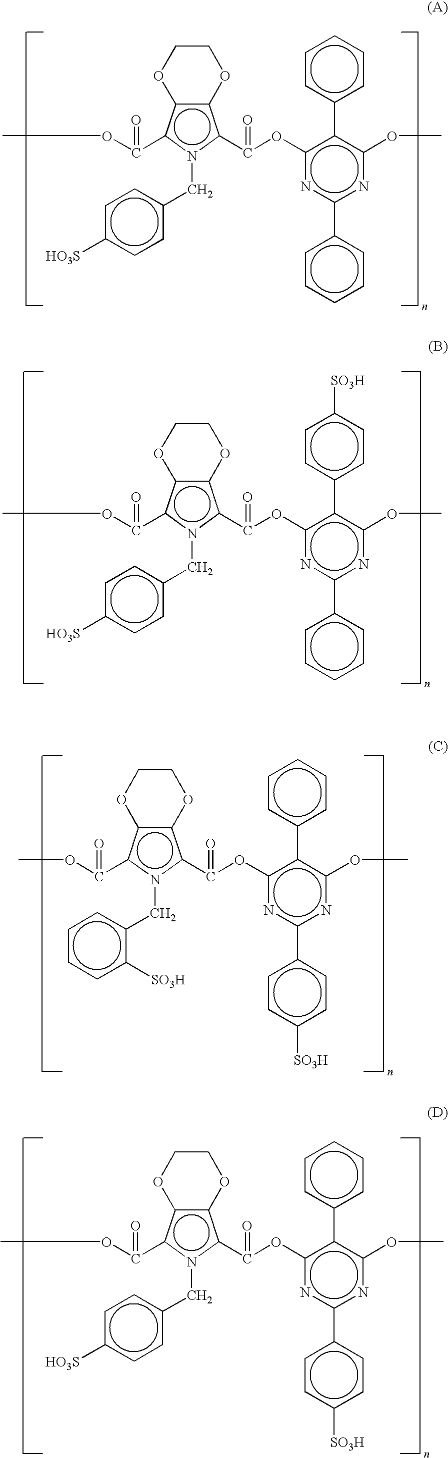

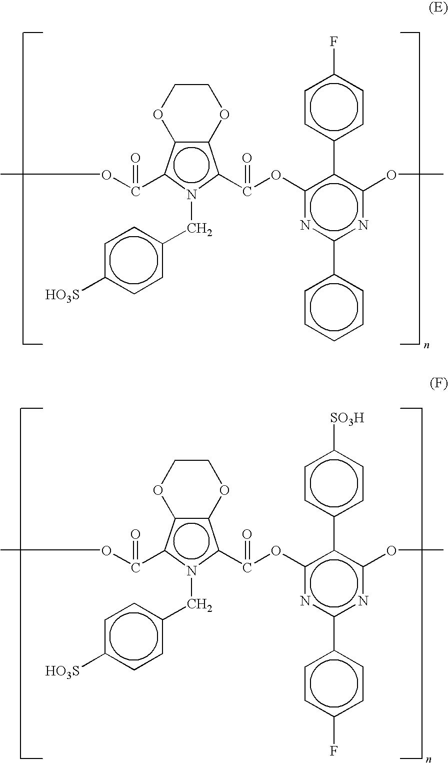

According to another embodiment of the present invention, there is provided a direct methanol fuel cell comprising an anode to which an aqueous methanol solution is fed, a cathode to which an oxidant is fed, and a polymer electrolyte membrane disposed between the anode and the cathode and comprising a heterocyclic ester copolymer represented by the formula I.

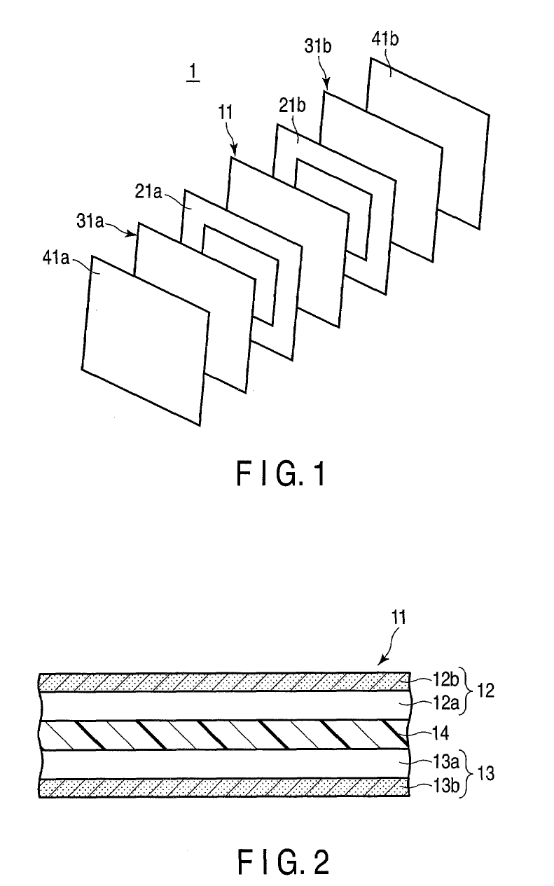

The direct methanol fuel cell according to this embodiment will be explained in detail with reference to FIGS. 1 and 2. FIG. 1 is an exploded perspective view schematically showing a unit cell and FIG. 2 is a sectional view showing a membrane electrode unit incorporated into the unit cell of FIG. 1.

A unit cell 1 is provided with a membrane electrode unit 11 as shown in FIG. 1. A frame-like seal material 21a, a fuel passage plate 31a and a current collecting plate 41a are arranged and laminated in this order on one surface of the membrane electrode unit 11. A frame-like seal material 21b, an oxidizing gas passage plate 31b and a current collecting plate 41b are arranged and laminated in this order on the other surface of the membrane electrode unit 11.

As shown in FIG. 2, the membrane electrode 11 is provided with an anode 12 to which an aqueous methanol solution is fed, a cathode 13 to which an oxidant is fed and a polymer electrolyte membrane 14 disposed between these anode 12 and cathode 13 and containing a heterocyclic ester copolymer represented by the formula I. The anode 12 is constituted of a catalyst layer 12a which is in contact with the polymer electrolyte membrane 14 and a current collector (diffusion layer) 12b laminated on the catalyst layer 12a and made of, for example, carbon paper. The cathode 13 is constituted of a catalyst layer 13a which is in contact with the polymer electrolyte membrane 14 and a current collector (diffusion layer) 13b laminated on the catalyst layer 13a and made of, for example, carbon paper.

The polymer electrolyte membrane according to the embodiment comprises a heterocyclic ester copolymer represented by the formula I. The polymer electrolyte membrane has high non-affinity (high resistance) to methanol, since the membrane does not have plural carbon fluorides on its principal chain and side chain unlike the current polymer electrolyte membrane made of Nafion 112 (trademark, manufactured by DuPont.). Also, because hydrogen can be coordinated with nitrogen of diphenylpyrimidine represented by the formula I, the polymer electrolyte membrane can develop high proton conductivity by a combination of hydrogen and the sulfonic acid group bound at least with dioxypyrrole. Moreover, the microstructure of the copolymer skeleton allows water to be collected and to exist as combined water. For this reason, the polymer electrolyte membrane containing the heterocyclic ester copolymer can be prevented from freezing at a temperature as low as −70° C., and it can develop high proton conductivity in a low temperature range.

In the case of interposing a polymer electrolyte membrane containing a heterocyclic ester copolymer of the formula I between the anode and the cathode to constitute a cell of a direct methanol fuel cell, the occurrence of the methanol crossover phenomenon can be efficiently limited because of the high non-affinity (resistance) of the polymer electrolyte membrane to methanol. Also, the hydrogen ions (protons) generated on the anode to which the aqueous methanol solution is supplied can be rapidly transferred to the cathode to which the oxidant is supplied, from the polymer electrolyte membrane having high proton conductivity at a temperature ranging from ambient temperature to low temperatures.

As a result, a direct methanol fuel cell can be provided which can attain efficient utilization of methanol and also maintain high output characteristics for a long period.

The present invention will be explained in detail by way of examples, in which all designations of “parts” indicate “parts by weight”, unless otherwise noted.

### SYNTHETIC EXAMPLE 1

In a round bottomed reactor fitted with an overhead stirrer and a Dimroth condenser, 10 parts of 4,6-dihydroxy-2-phenylsulfonic acid-5-phenylpyrimidine and 18 parts of 1-benzylsulfonic acid-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-phenylsulfonic acid-5-phenylpyrimidine-1-benzylsulfonic acid-3,4-ethylenedioxypyrrole-2,5-dicarboxylate polymer represented by the structural formula (A) (n in the formula: 30). The structural formula (A) was identified by the following characteristic absorption wavelength (all units are cm⁻¹) measured using a Fourier transformation infrared spectrum analyzer (trade name: Spectrum 100, manufactured by Perkin Elmer Japan Co., Ltd.) by the KBr tablet method using 1 mmg of a sample.

Benzene nucleus: 3060, 3020,

Pyrimidine: 3090,

Pyridine: 3070,

Ester bond: 1740, 1770,

Ether: 1050,

Sulfonic acid: 3500, 1650, 1200.

### SYNTHETIC EXAMPLE 2

In a round bottomed reactor fitted with an overhead stirrer and a Dimroth condenser, 10 parts of 4,6-dihydroxy-2-phenyl-5-(p-phenylsulfonic acid)pyrimidine and 18 parts of 1-benzyl(p-sulfonic acid)-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-phenyl-5-(p-phenylsulfonic acid)pyrimidine-1-benzyl(p-sulfonic acid)-3,4-ethylenedioxypyrrole-2,5-dicarboxylate polymer represented by the structural formula (B) (n in the formula: 60). The structural formula (B) was identified by the following characteristic absorption wavelength (all units are cm⁻¹) measured using a Fourier transformation infrared spectrum analyzer (trade name: Spectrum 100, manufactured by Perkin Elmer Japan Co., Ltd.) by the KBr tablet method using 1 mmg of a sample.

Benzene nucleus: 3070, 3050,

Pyrimidine: 3085,

Pyridine: 3080,

Ester bond: 1730, 1780,

Ether: 1060,

Sulfonic acid: 3520, 1680, 1205.

### SYNTHETIC EXAMPLE 3

In a round bottomed reactor fitted with an overhead stirrer and a Dimroth condenser, 10 parts of 4,6-dihydroxy-2-(p-phenylsulfonic acid)-5-phenylpyrimidine and 18 parts of 1-benzyl(o-sulfonic acid)-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-(p-phenylsulfonic acid)-5-phenylpyrimidine-1-benzyl(o-sulfonic acid)-3,4-ethylenedioxypyrrole-2,5-dicarboxylate polymer represented by the structural formula (C) (n in the formula: 200). The structural formula (C) was identified by the following characteristic absorption wavelength (all units are cm⁻¹) measured using the Fourier transformation infrared spectrum analyzer (trade name: Spectrum 100, manufactured by Perkin Elmer Japan Co., Ltd.) by the KBr tablet method using 1 mmg of a sample.

Benzene nucleus: 3075, 3045,

Pyrimidine: 3085,

Pyridine: 3080,

Ester bond: 1760, 1780,

Ether: 1080,

Sulfonic acid: 3525, 1685, 1215.

### SYNTHETIC EXAMPLE 4

In a round bottomed reactor fitted with an overhead stirrer and a Dimroth condenser, 10 parts of 4,6-dihydroxy-2-(p-phenylsulfonic acid)-5-phenylpyrimidine and 18 parts of 1-benzyl(p-sulfonic acid)-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-(p-phenylsulfonic acid)-5-phenylpyrimidine-1-benzyl(p-sulfonic acid)-3,4-ethylenedioxypyrrole-2,5-dicarboxylate polymer represented by the structural formula (D) (n in the formula: 300). The structural formula (D) was identified by the following characteristic absorption wavelength (all units are cm⁻¹) measured using the Fourier transformation infrared spectrum analyzer (trade name: Spectrum 100, manufactured by Perkin Elmer Japan Co., Ltd.) by the KBr tablet method using 1 mmg of a sample.

Benzene nucleus: 3070, 3050,

Pyrimidine: 3090,

Pyridine: 3080,

Ester bond: 1750, 1770,

Ether: 1080,

Sulfonic acid: 3530, 1690, 1220.

### SYNTHETIC EXAMPLE 5

In a round bottomed reactor fitted with an overhead stirrer and a Dimroth condenser, 10 parts of 4,6-dihydroxy-2-phenyl-5-(p-fluorophenyl)pyrimidine and 18 parts of 1-benzyl(p-sulfonic acid)-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-phenyl-5-(p-fluorophenyl)pyrimidine-1-benzyl(p-sulfonic acid)-3,4-ethylenedioxypyrrole-2,5-dicarboxylate polymer represented by the structural formula (E) (n in the formula: 500). The structural formula (E) was identified by the following characteristic absorption wavelength (all units are cm⁻¹) measured using the Fourier transformation infrared spectrum analyzer (trade name: Spectrum 100, manufactured by Perkin Elmer Japan Co., Ltd.) by the KBr tablet method using 1 mmg of a sample.

Benzene nucleus: 3080, 3060,

Pyrimidine: 3070,

Pyridine: 3080,

Ester bond: 1740, 1760,

Ether: 1050,

Sulfonic acid: 3500, 1670, 1225,

Fluorophenyl: 680, 700, 3000.

### SYNTHETIC EXAMPLE 6

In a round bottomed reactor fitted with an overhead stirrer and a Dimroth condenser, 10 parts of 4,6-dihydroxy-2-(p-fluorophenyl)-5-(p-phenylsulfonic acid)pyrimidine and 18 parts of 1-benzyl(p-sulfonic acid)-3,4-ethylenedioxypyrrole-2,5-dicarboxylate were stirred in tetrahydrofuran to polymerize. The reaction solution was dissolved in an aqueous 5% ethanol solution and the resulting solution was poured into a dialysis tube to dialyze for 24 hours, thereby carrying out desalting and purification to synthesize a copolymer.

The obtained copolymer was a 4,6-dihydroxy-2-(p-fluorophenyl)-5-(p-phenylsulfonic acid)pyrimidine-1-benzyl(p-sulfonic acid)-3,4-ethylenedioxypyrrole-2,5-dicarboxylate polymer represented by the structural formula (F) (n in the formula: 600). The structural formula F was identified by the following characteristic absorption wavelength (all units are cm⁻¹) measured using the Fourier transformation infrared spectrum analyzer (trade name: Spectrum 100, manufactured by Perkin Elmer Japan Co., Ltd.) by the KBr tablet method using 1 mmg of sample.

Benzene nucleus: 3090, 3060,

Pyrimidine: 3055,

Pyridine: 3070,

Ester bond: 1730, 1760,

Ether: 1050,

Sulfonic acid: 3500, 1680, 1230,

Fluorophenyl: 690, 710, 3005.

### EXAMPLES 1 TO 6

Each copolymer obtained in above Synthetic Examples 1 to 6 was dissolved in 30 mL of N,N-dimethylformamide and the obtained solution was stretched into a glass plate-like material by using a bar coater. The glass plate-like material was dried in air and then dried under vacuum for 4 hours. The obtained cast film (polymer electrolyte membrane) was peeled off by using a pincette and dipped in 0.02 mol/L of hydrochloric acid to reserve it.

(Production of an Anode)

A platinum-ruthenium-carrying carbon particles were dispersed in a solution containing 5 wt % of a perfluoroalkylsulfonic acid polymer (trademark: Nafion 112, manufactured by DuPont.) to prepare a slurry. The obtained slurry was applied to the surface of carbon paper by using a coater to produce an anode having a catalyst layer carrying 2 mg/cm² of platinum ruthenium.

(Production of a Cathode)

100 parts of an aqueous 1 wt % chloroplatinic acid solution was added in 10 parts of Kechen Black and the mixture was stirred. When the viscosity of the whole solution was increased, 100 parts by weight of an aqueous 5 wt % hydrazine solution was added to the solution, which was then stirred to make carbon particles carry platinum. 30 parts by weight of platinum-carrying carbon particles and 100 parts by weight of a 5 wt % perfluoroalkylsulfonic acid polymer (trademark: Nafion 112, manufactured by DuPont.) were mixed and the mixture was stirred. When the viscosity of the solution was increased, the stirring was stopped to prepare a slurry. The obtained slurry was applied to the surface of carbon paper by using a coater to produce a cathode having a catalyst layer carrying 1 mg/cm² of platinum.

(Production of a Membrane Electrode)

Each of the above cast films was disposed as the electrolyte membrane between the obtained anode and cathode so as to be in contact with each catalyst layer. Then, the electrode material was processed by hot-pressing to manufacture a membrane electrode.

Also, a perfluoroalkylsulfonic acid polymer (trademark: Nafion 112, manufactured by DuPont.) was disposed as the electrolyte membrane between the obtained anode and cathode so as to be in contact with each catalyst layer. Then, the electrode material was processed by hot-pressing to manufacture a membrane electrode (Comparative Example 1).

(Fabrication of a Unit Cell)

Each of the obtained membrane electrode (electrode area: 5 cm²) was sandwiched between two pairs of carbon separators having a column flow passage and current collectors, which was then fastened using a bolt to fabricate an evaluation unit cell.

<Evaluation of the Unit Cell>

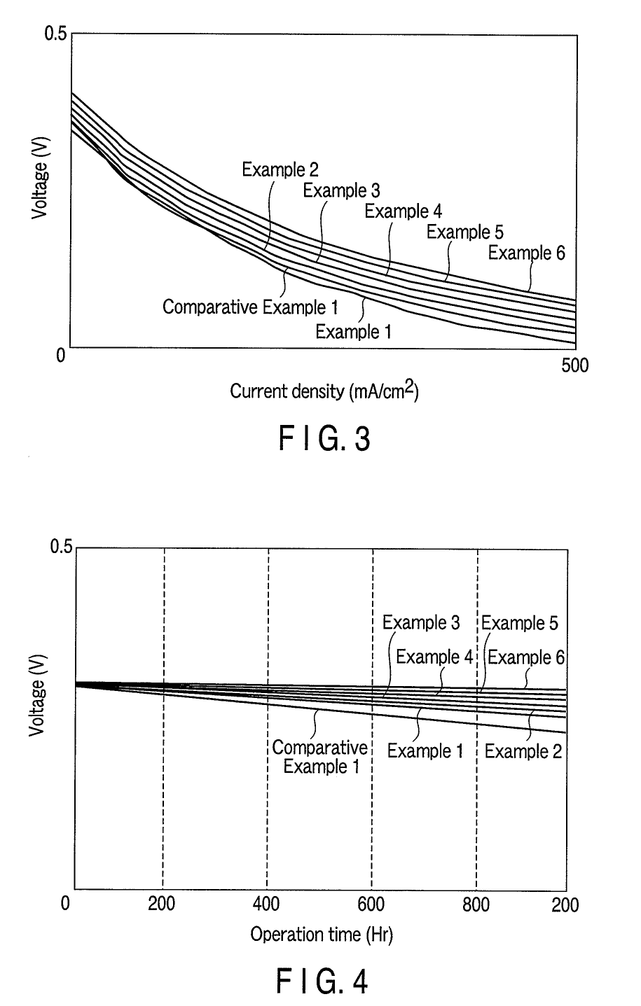

Each unit cell obtained in Examples 1 to 6 and Comparative Example 1 was connected to a fuel cell evaluation instrument. An aqueous 3 wt % methanol solution (fuel) was fed to the anode side of the unit cell at a rate of 5 mL/min., and air was fed to the cathode side of the unit cell at a rate of 10 mL/min., to measure the current-voltage characteristic of the unit cell at 50° C. The results are shown in FIG. 3.

As is clear from FIG. 3, it is found that each of the unit cells of Examples 1 to 6 can output a higher voltage than the unit cell of Comparative Example 1.

Each unit cell obtained in Examples 1 to 6 and Comparative Example 1 was connected to a fuel cell evaluation instrument. An aqueous 3 wt % methanol solution (fuel) was fed to the anode side of the unit cell at a rate of 5 mL/min., and air was fed to the cathode side of the unit cell at a rate of 10 mL/min., to observe a variation in the voltage of the unit cell when the unit cell was operated at 50° C. for 1000 hours while maintaining a constant current density of 100 mA/cm². The results are shown in FIG. 4.

As is clear from FIG. 4, it is found that each unit cell of Examples 1 to 6 exhibits a higher potential retentivity than the unit cell of Comparative Example 1 even after it is operated for a long period, ensuring that it can attain highly reliable power generation.

(Evaluation of Proton Conductivity)

<Production of an Electroconductivity Measuring Cell>

a-1) Two fluororesin plates were prepared which were each made of a polytetrafluoroethylene and provided with a through-trap having dimensions [cm] of 0.5 (length)×1.0 (width)x 1.0 (depth) at its center. A platinum foil 0.30 mm in thickness was cut into a size of 0.5×2.0 cm to form an electrode, which was then applied to the 0.5 cm-side of the trap of each fluororesin plate such that the end side (0.5 cm) of the electrode accorded exactly to the 0.5 cm-side of the trap by using a double coated tape. A protective tape extending from the position 0.7 cm apart from the end of the trap to the other end was applied to the surface part of the above electrode so that the area of the electrode was 0.35 cm².

a-2) The surface of the platinum electrode was plated with platinum black in the following procedures. Specifically, 0.008 g of lead acetate (Pb(CH₃COO)₂.3H₂O) and 1 g of chloroplatinic acid (H₂PtCl₆.6H₂O) were dissolved in 30 mL of 1/40 N hydrochloric acid to prepare a plating solution. The fluororesin plates with the platinum electrode which were produced in the above a-1) were dipped one by one in this plating solution, which was then set to a DC voltage-current generator (trade name: R1644, manufactured by Advantest) so as to place these plates in the following condition: bath voltage: 3.0 V, current: 14 mA and current density: 40 mA/cm². In succession, in order to plate the above two electrodes alternately little by little, an operation was continued which changed the switch of the device from positive to negative and vice versa every one minute to thereby switch the electrode from positive to negative and vice versa for 50 minutes. After that, these two electrodes were washed with distilled water. Then, the platinum black electrode plate was made negative and another platinum electrode plate was made to be positive in 10% dilute sulfuric acid to apply a voltage of 3 V for 10 minutes, thereby removing the plating solution and adsorbed chlorine. Finally, the electrodes were washed thoroughly with distilled water and stored in distilled water.

b) Each cast film of Examples 1 to 6 was cut into a size of 15 mm×12 mm to make a sample film for measuring electroconductivity by the alternate current method (call/call plot). In succession, the sample film was overlapped on the trap of a first fluororesin plate which was formed by using the above method, provided with a platinum electrode plated partly with platinum black and had holes opened at four corners, in such a manner as to cover the platinum black plating part including the trap. A second fluororesin plate which was provided with the same platinum electrode plated partly with platinum black and had holes opened at four corners was overlapped on the first fluororesin plate in such a manner that both traps accorded to each other, the platinum electrodes of the first and second fluororesin plates were projected in the directions opposite to each other and the platinum black plating part of the second fluororesin plate was in contact with the above sample film to hold the sample film between these first and second fluororesin plates. In succession, a bolt was inserted into each hole opened in the four corners of each of the first and second fluororesin plates and a nut was fitted to the bolt to secure the first and second fluororesin plates to each other. Thereafter, about 0.3 mL of an aqueous 0.03 N hydrochloric acid solution was filled in the traps of the first and second fluororesin plates by utilizing the capillary phenomenon so as to cover the whole and both surfaces of the sample film to thereby produce an electroconductivity measuring cell.

In Comparative Example 1, similarly, a Nafion 112 (trademark, manufactured by DuPont.) film was cut into a size of 15 mm×12 mm to make a sample film for measuring electroconductivity by the alternate current method (call/call plot). Then, the sample film was held between the first and second fluororesin plates and about 0.3 mL of an aqueous 0.03 N hydrochloric acid was filled in the traps of the first and second fluororesin plates so as to cover the whole and both surfaces of the sample film to thereby produce an electroconductivity measuring cell.

Then, each measuring cell obtained in Examples 1 to 6 and Comparative Example 1 was secured to a stand and each platinum electrode was connected to a Solatron-impedance/gain-phase analyzer SI1260. Alternating current was made to flow through the sample film (Nafion film) while reducing the frequency of the current from the high-frequency side to the low-frequency side. The resistance values obtained at this time were plotted against a real number axis and an imaginary number axis (call/call plot). Generally, the curve in the graph obtained in this case includes a semicircle line drawn on the high-frequency side and, subsequently, a linear line continuing to rise on the low-frequency side. The diameter of the semicircle indicates the resistance of the sample. In this measurement, the radius of this semicircle was estimated and the electroconductivity of a Nafion film-H-type was calculated from the obtained value to find the resistance of the film. The distance within which current flows in the film is 0.5 cm based on the structure of the cell. Therefore, the electroconductivity of the film is given by the following formula (1).

$$\begin{matrix}Proton conductivity ( {W}^{- 1} \cdot {cm}^{- 1} ) = \frac{Electrode spacing}{( Film sectional area \times Film resistance )} \\ = \frac{0.5 [ cm )}{( \begin{matrix}Film width 1.0 [ cm ] \times \\ Film thickness [ cm ] \times \\ Film resistance [ W ]\end{matrix} )}\end{matrix}$$

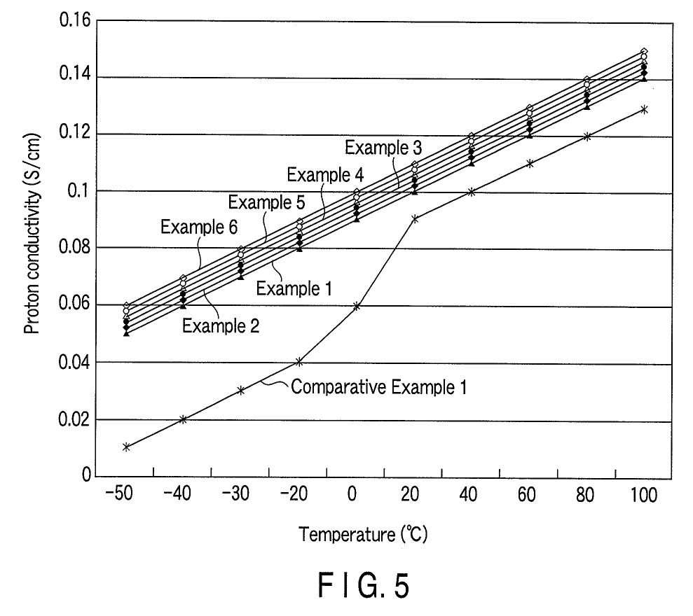

The temperature dependency of the proton conductivity calculated from each measuring cell of Examples 1 to 6 and Comparative Example 1 is shown in FIG. 5.

As is clear from FIG. 5, it is found that each polymer electrolyte membrane of Examples 1 to 6 has higher proton conductivity than the Nafion 112 (trademark, manufactured by DuPont.) film used in Comparative Example 1 in a low-temperature range, showing that the proton conductivity is outstandingly improved.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A polymer electrolyte membrane for use in a direct methanol fuel cell, comprising a heterocyclic ester copolymer represented by the following formula (I): 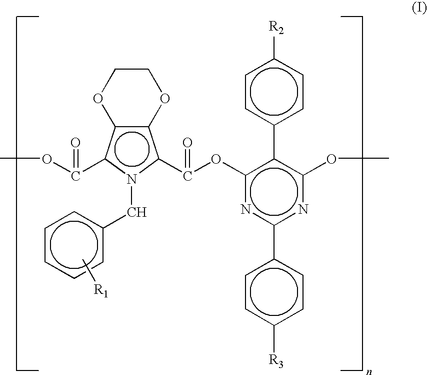
wherein R₁ represents a sulfonic acid group,
wherein each of R₂ and R₃ which may be the same or different, respectively, represents a sulfonic acid group, hydrogen, or fluorine,
and wherein n is an integer from 30 to 600.

2. The polymer electrolyte membrane of claim 1, wherein n in the formula I is an integer from 60 to 300.

3-8. (canceled)

9. A direct methanol fuel cell comprising:
an anode to which an aqueous methanol solution is fed;
a cathode to which an oxidant is fed; and
a polymer electrolyte membrane disposed between the anode and the cathode, comprising a heterocyclic ester copolymer represented by the following formula (I): 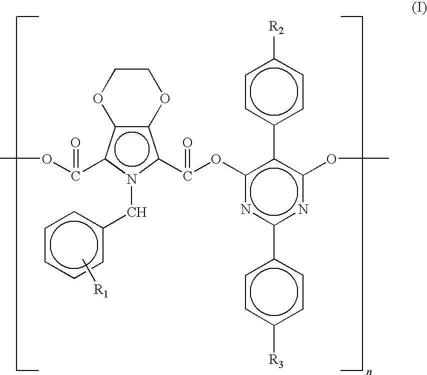
wherein R₁ represents a sulfonic acid group,
wherein each of R₂ and R₃ which may be the same or different, respectively, represents a sulfonic acid group, hydrogen, or fluorine,
and wherein n is an integer from 30 to 600.

10. The direct methanol fuel cell of claim 9 wherein n in the formula I is an integer from 60 to 300.
